(19) United States
(12) Patent Application Publication
(10) Pub. No.: US 2026/0208378 A1
(43) Pub. Date: Jul. 23, 2026

(54) SLICING UNIT FOR AN AUTOMATIC SLICER MACHINE

(71) Applicant: ALIMEC S.R.L., Valli del Pasubio (VI) (IT)

(72) Inventor: Arianna Roso, Torrebelvicino (VI) (IT)

(73) Assignee: ALIMEC S.R.L., Valli del Pasubio (VI) (IT)

(21) Appl. No.: 19/138,943

(22) PCT Filed: Dec. 11, 2023
(86) PCT No.: PCT/IT2023/050276

§ 371 Date: Jun. 13, 2025

(30) Foreign Application Priority Data
Dec. 13, 2022 (IT) 102022000025422

(51) Int. Cl. B26D 1/54; B26D 1/00

(52) U.S. Cl. CPC B26D 1/54; B26D 1/0006; B26D 2001/0013; B26D 2210/02

(57) ABSTRACT

Slicing unit (10) for cutting food products into slices (F), comprising two plates (11, 12) interspaced to define a hollow space (13). On a terminal edge of one of said plates (11) a guide element (14) is attached in which a housing slot (15) is created in which a bandsaw blade (16) is positioned sliding.

### FIELD OF THE INVENTION

The present invention concerns a slicing unit for an automatic slicer machine which is typically used, at an industrial level, for cutting products such as cured meats, sausages, cheeses, vegetables, bread but also other foods. The slices obtained can be packaged in groups, according to a particular weight requirement, or they can be distributed continuously on semi-finished foods which must be filled/topped, such as pizzas, focaccia, cakes, sandwiches, toast and still others.

### BACKGROUND OF THE INVENTION

In the industrial food sector, automatic slicer machines are known which comprise a base on which both an oscillating head, movable with pendulum movement or with horizontal movement, and equipped with one or more product-holding loaders, and a slicing unit are mounted.

The slicing unit comprises two plates interspaced to define a hollow space to allow the slices to fall, which are optionally suitably directed by means of a comb. A guide element, or blade guide, is attached on a terminal edge of one of the two plates, in which a housing slot is created where a bandsaw blade moved by means of pulleys and having a cutting thickness of 0.5 mm is positioned sliding. The terminal edge of the other plate is instead provided with an abutment element useful to adjust the cutting thickness.

The oscillation speed of the oscillating head, which determines the consequent movement of the product-holding loaders, is regulated by a servomotor so that, during the cutting step, it is possible to obtain different deposit configurations of the slices as well as to adapt the cutting to the different loaded products, which can be very different from each other in terms of temperature, density and volume.

In the industrial food sector, the need is particularly felt to obtain slices of homogeneous thickness, of regular and defined shape, and of a desired weight. However, the slicing units of the prior art suffer from a series of drawbacks, essentially related to the blade thickness, which prevent meeting such a need.

In fact, it is known that the repeated stresses which the product exerts on the blade during cutting cause a bending thereof and consequently a non-homogeneous thickness of the slices.

Furthermore, such stresses affect the life of the blade, which must therefore be replaced more often, resulting in machine downtime and decreased productivity.

The blade guide also suffers non-negligible wear since the blade exerts a pressure on the bottom of the housing slot every time the product comes into contact with the blade itself.

There is therefore the need to perfect a slicing unit for an automatic slicer machine that can overcome at least one of the disadvantages of the state of the art.

To do this, it is necessary to solve the technical problem of optimizing the blade of the slicing unit and the corresponding blade guide in order to obtain product slices with homogeneous thickness, regular and defined shape, and of a desired weight, as well as a more precise distribution of the slices themselves inside a container or on the surface of semi-finished foods which advance continuously.

Another purpose of the present invention is to provide a slicing unit in which the blade and the blade guide are less subject to replacement because they have a longer useful life.

A further purpose of the present invention is to constructively simplify the creation of the housing slot provided in the blade guide, thus reducing the creation costs thereof.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, a slicing unit according to the present invention for cutting food products into slices, such as cured meats, sausages, cheeses, vegetables, bread but also other foods, comprises two plates interspaced to define a hollow space to allow the fall of said slices, on a terminal edge of one of said plates there being attached a guide element in which a housing slot is created in which a bandsaw blade is positioned sliding.

In accordance with one aspect of the present invention, a ratio between a blade thickness of said bandsaw blade and a slot thickness of said housing slot is comprised between 0.65 and 0.75.

In accordance with another aspect of the present invention, said ratio is around 0.7.

In accordance with another aspect of the present invention, said blade thickness is equal to 0.7 mm.

In accordance with another aspect of the present invention, said slot thickness is equal to 1 mm.

In accordance with another aspect of the present invention, said bandsaw blade has a cutting part comprising two inclined surfaces, defining between them an edge with an asymmetrical cutting angle equal to about 30°.

In accordance with another aspect of the present invention, said housing slot is delimited by a bottom wall and by two additional walls having a different extension.

In accordance with another aspect of the present invention, said guide element is surface coated with a layer of anti-wear, stainless material suitable for contact with said food products.

In accordance with another aspect of the present invention, it comprises movement means formed by a pair of pulleys around which said bandsaw blade is driven, and by a motor associated with one of said pulleys.

Embodiments of the present invention also refer to an automatic slicer machine comprising a base on which there are mounted both an oscillating head, able to be moved with a pendulum-like or horizontal movement, and equipped with one or more product-holding loaders, and a slicing unit as previously described.

Embodiments of the present invention also relate to an automatic filling line for filling semi-finished products comprising means for continuously feeding said semi-finished products in a direction of feed, one or more filling machines and an automatic slicer machine, as previously described, disposed in said direction of feed above said continuous feed means.

The present invention allows to obtain at least the following advantages:
a reduction in the bending of the bandsaw blade which therefore has a longer life and allows to obtain more precise slices (thickness and weight);
a decrease in the costs for creating the housing slot;
a decrease in the surface pressure that the bandsaw blade exerts cyclically on the bottom of the housing slot at the same imposed load with a consequent longer life of the guide element;
an improvement in the overall quality of the slices regardless of the conditions of the food product, which in the prior art is a variable affecting the final result;
an improved deposition trajectory of the slices regardless of their thickness.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic sectional front view of a slicing unit according to the present invention;

FIG. 2 is a sectional front view showing the guide element and the bandsaw blade slidably inserted in the housing slot;

FIG. 3 is an enlarged detail of FIG. 2;

FIG. 3a is an enlarged detail of the cutting part of the bandsaw blade;

FIG. 4 is a schematic view of an automatic slicer machine on which the slicing unit of FIG. 1 is installed;

FIG. 5 is a schematic view of an automatic filling line comprising the automatic slicer machine of FIG. 4.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF ONE EMBODIMENT OF THE PRESENT INVENTION

With reference to FIG. 1, a slicing unit 10 according to the present invention is used, typically at an industrial level, for cutting food products M into slices F, such as cured meats, sausages, cheeses, vegetables, bread but also other foods, even very different from each other in terms of temperature, density and volume.

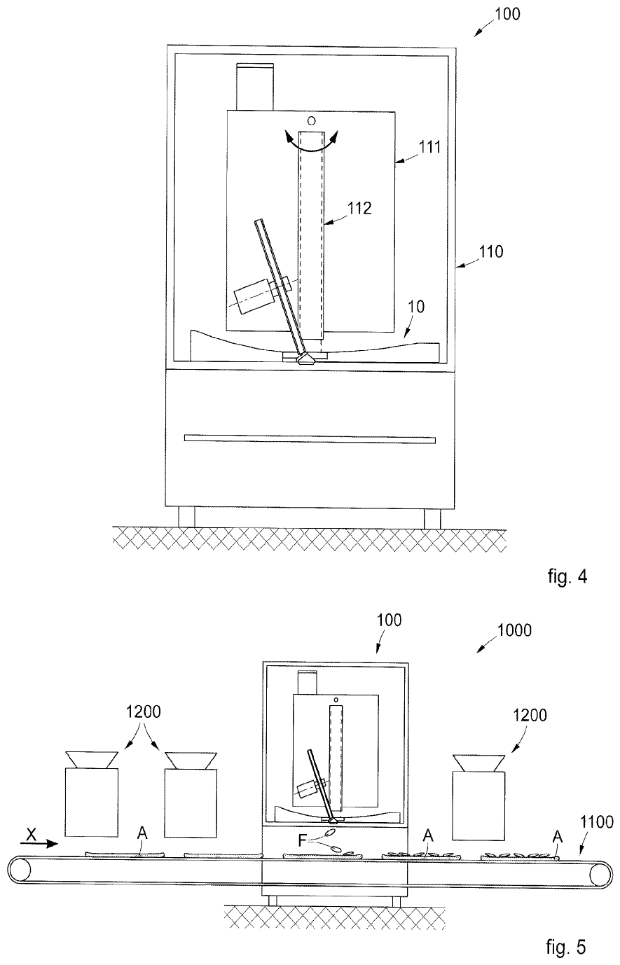

The slicing unit 10 is normally part of an automatic slicer machine 100, exemplarily illustrated in FIG. 4, which can be used, for example, in an automatic filling line, exemplarily illustrated in FIG. 4, of pizzas, focaccia, cakes, sandwiches, toast and others, in order to dispose, by falling, the slices F on the surfaces of these semi-finished foods A as they advance.

With reference to FIG. 1, the slicing unit 10 comprises two radial plates 11, 12, interspaced to define a longitudinal hollow space 13 to allow said slices F to fall downwards.

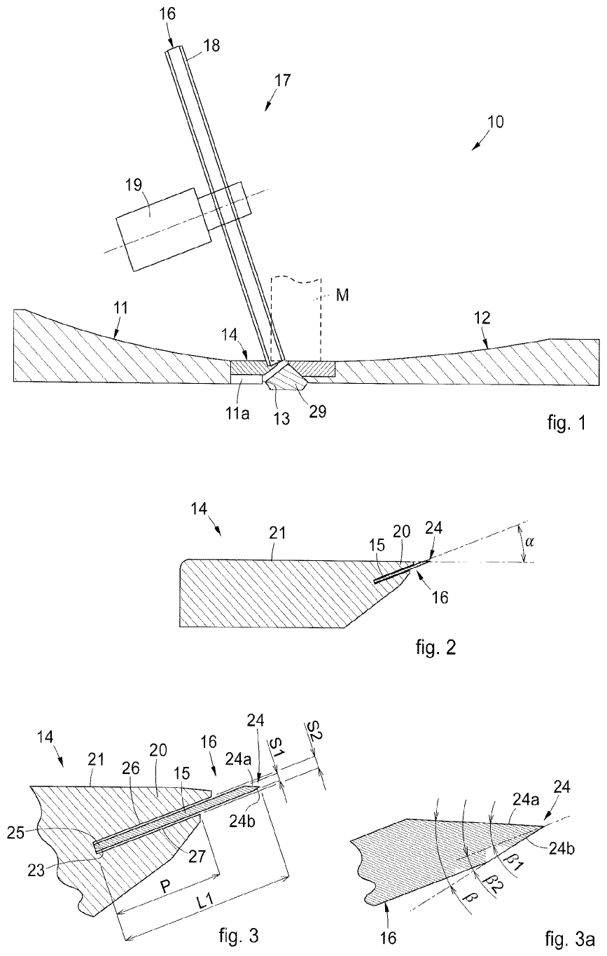

On a terminal edge 11a of a first plate 11, a guide element 14 is attached in which a housing slot 15 is created where a bandsaw blade 16 is positioned sliding, see FIGS. 2-3.

Below the two plates 11, 12, disposed in the hollow space 13, an orientation element 29, or comb may be present, configured to appropriately direct the slices F downwards while they are being made, FIG. 1 where the slicing unit 10 comprises movement means 17 for moving the bandsaw blade 16.

The movement means 17 are formed by a pair of pulleys 18, of which only one is visible in FIG. 1, around which the bandsaw blade 16 is driven, according to a closed loop path. Therefore, the bandsaw blade 16 has an overall length equal to twice the spacing between the pulleys 18 plus a portion equal to the curved return sections around the latter.

One of the pulleys 18 is connected to an electric motor 19 while the other pulley 18 can be idle.

The movement means 17 also comprise a tensioning device (not shown) configured to maintain the correct tension of the bandsaw blade 16 during the operation of the slicing unit 10.

The bandsaw blade 16 essentially has a rectangular cross-section with blade thickness S1 and blade width L1, while the housing slot 15 has a slot thickness S2 and a slot depth P, as illustrated in FIG. 3.

According to one aspect of the present invention, a ratio of the blade thickness S1 to the slot thickness S2 is comprised between 0.65 and 0.75, preferably around 0.7.

According to embodiments, the blade thickness S1 is comprised between about 0.6 mm and about 0.8 mm, preferably around 0.7 mm; the slot thickness S2 is comprised between about 0.9 mm and about 1.1 mm, preferably around 1 mm.

The Applicant has experimented that: a) a blade thickness S1 equal to 0.7 mm, unlike what is provided in the prior art, allows to reduce the bending of the bandsaw blade 16 and to obtain a cutting of the slices F with a more precise thickness; b) a corresponding slot thickness S2 equal to 1 mm entails at least a direct advantage on the costs for creating the housing slot 15 due to the fact that the tools used are less expensive, break less frequently and thus need to be replaced less often.

According to embodiments, the guide element 14 is provided with a support part 20, at an end edge thereof, in which the housing slot 15 is made, FIGS. 2-3.

The housing slot 15 is made inclined with an inclination a equal to about 20°, with respect to a substantially flat upper surface 21 of the guide element 14, FIG. 2.

The inclination of the housing slot 15 allows the bandsaw blade 16 to be suitably oriented with respect to the food product M which is moved against it from time to time.

The housing slot 15 is made along the entire length of the guide element 14 so that the bandsaw blade 16 enters from an attachment end and exits from an outlet end of the housing slot 15, continuously and with high speed controllable by the electric motor 19.

With reference to FIG. 3, the housing slot 15 has a bottom wall 23 against which the bandsaw blade 16 abuts. Whenever the food product engages the bandsaw blade 16, the latter receives a shock and consequently exerts a pressure on the bottom wall 23.

The housing slot 15 is delimited by the bottom wall 23 and by two further walls 26, 27, upper and lower, having different extension and defining an upper and lower stop for the bandsaw blade 16. In other words, the housing slot 15 is a sort of pocket open at the ends thereof for the entry and exit of the bandsaw blade 16, and longitudinally to “offer” a cutting part 24 of the bandsaw blade 16 to the food product to be cut.

The combination of optimal values of the slot thickness S2 and the cutting thickness S1 described above entails a further technical advantage, related to the fact that the surface pressure exerted on the bottom wall 23 is about 30% less compared to what normally occurs in the prior art. Such a value was calculated considering a load equal to 50 Kg distributed on a section of blade equal to about 25 mm. Therefore, the guide element 14 also has a longer useful life.

Such a combination of values has a direct impact on the food product M to be cut, as the cut is less affected by the conditions of the food product M which can be temperature, density and volume, humidity. In particular, the small slices which are normally more difficult to direct and dispose are more “firm” and the large slices are more regular in weight.

The bottom wall 23 is substantially flat with a height equal to the slot thickness S2 and a length equal to a length of the guide element 14.

The housing slot 15 has a depth P which is smaller than the width L1 of the bandsaw blade 16 so that at least the cutting part 24 of the latter is protruding with respect to the guide element 14 for cutting the food product M.

The cutting part 24 is opposite a stop part 25 of the bandsaw blade 16, essentially defined by a flat rectangular surface, with which the bandsaw blade 16 engages the bottom wall 23.

With reference to FIG. 3a, the cutting part 24 comprises two cutting surfaces 24a, 24b inclined and defining between them an edge with an asymmetrical cutting angle β equal to about 30°.

The cutting part 24 is preferably defined by an asymmetrical double bevel.

In other words, considering a reference plane parallel to two opposite flat surfaces of the bandsaw blade 16 and passing through the edge defined by the junction of the cutting surfaces 24a, 24b, the cutting angle β is formed by a first cutting sub-angle β1 between a first cutting surface 24a and the reference plane, and by a second cutting sub-angle β2 between a second cutting surface 24b and the reference plane.

The first cutting sub-angle β1 is smaller than the second cutting sub-angle β2. The second cutting sub-angle β2 is equal to about 10°.

The cutting thickness S1, according to the present invention, also affects the life of the cutting part 24. In fact, the “edge” life of the bandsaw blade 16 is greater and this is essentially reflected in two advantages: a) the bandsaw blade 16 cuts better for a longer time, reducing blade change operations per shift; b) the improved cutting for a longer time loads the hollow bottom surface 23 less, lengthening the life thereof.

With reference to FIG. 4, an automatic slicer machine 100 is exemplarily illustrated comprising a base 110 on which there are mounted both an oscillating head 111, able to be moved with a pendulum-like movement, and equipped with one or more product-holding loaders 112, and a slicing unit 10 according to the present invention.

With reference to FIG. 5, an automatic filling line 1000 for filling semi-finished products A comprising means 1100 for continuously feeding 1100, in particular a belt, for feeding the semi-finished products A in a direction of feed X, one or more filling machines 1200, configured to dose and dispose ingredients on the semi-finished products A, and an automatic slicer machine 100, disposed in the direction of feed X of the continuous feed means 1100, is exemplarily illustrated.

The Applicant has experimented that the automatic slicer machine 100, with the characteristics expressed above related to the slicing unit 10, is capable of disposing the slices F on the semi-finished products A more precisely compared to what occurs in the prior art.

It is clear that modifications and/or additions of parts may be made to the slicing unit 10, without thereby departing from the scope of the present invention as defined by the claims.

It is also clear that, although the present invention has been described with reference to some specific examples, a person of skill in the art shall certainly be able to achieve other equivalent forms of a slicing unit for an automatic slicer machine, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. The slicing unit for cutting food products into slices (F), comprising two plates interspaced to define a hollow space, on a terminal edge of one of said plates there being attached a guide element in which a housing slot is created in which a bandsaw blade is positioned sliding, wherein a ratio between a blade thickness of said bandsaw blade and a slot thickness of said housing slot is comprised between 0.65 and 0.75.

2. A slicing unit according to claim 1, wherein said ratio is around 0.7.

3. A slicing unit according to claim 1, wherein said blade thickness is equal to 0.7 mm.

4. A slicing unit according to claim 1, wherein said slot thickness is equal to 1 mm.

5. A slicing unit according to claim 1, wherein said bandsaw blade has a cutting part comprising two inclined surfaces, defining between them an edge with an asymmetrical cutting angle (β) equal to about 30°.

6. A slicing unit according to claim 1, wherein said housing slot is delimited by a bottom wall and by two additional walls having a different extension.

7. A slicing unit according to claim 1, wherein said guide element is surface coated with a layer of anti-wear, stainless material suitable for contact with said food products.

8. A slicing unit according to claim 1, wherein said slicing unit comprises movement means formed by a pair of pulleys around which said bandsaw blade is driven, and by a motor associated with one of said pulleys.

9. The automatic slicer machine comprising a base on which there are mounted both an oscillating head, able to be moved with a pendulum-like or horizontal movement and equipped with one or more product-holding loaders, and also a slicing unit according to claim 1.

10. The automatic filling line for filling semi-finished products comprising means for continuously feeding said semi-finished products in a direction of feed, one or more filling machines and an automatic slicer machine according to claim 9, all disposed in said direction of feed above said continuous feed means.
